(19) United States
(12) Patent Application Publication
(10) Pub. No.: US 2021/0285464 A1
(43) Pub. Date: Sep. 16, 2021

(54) Systems And Methods For Increasing The Efficiency Of Low Pressure Axial Fans

(71) Applicants: Dileep Dasari, Visakhapatnam (IN); Yong Zhong Sun, Selangor (MY)

(72) Inventors: Dileep Dasari, Visakhapatnam (IN); Yong Zhong Sun, Selangor (MY)

(21) Appl. No.: 16/332,621

(22) PCT Filed: Jul. 12, 2017
(86) PCT No.: PCT/IB2017/054191

§ 371 Date: Mar. 12, 2019

(51) Int. Cl. F04D 29/54; F04D 19/00

(52) U.S. Cl. CPC F04D 29/542; F04D 19/002

(57) ABSTRACT

A system for increasing the efficiency of low pressure axial fans, includes, a low pressure axial fan including multiple first blades, and, a vortex generator operably coupled to the low pressure axial fan via a shaft. In use, the vortex generator includes multiple second blades. In further use, the low pressure axial fan is configured to operate in an operational mode and the vortex generator is configured to operate in a stationary mode.

### FIELD OF THE INVENTION

Embodiments of the present invention generally relate to the field of axial fans, and, more particularly, to systems and methods for increasing the efficiency of low pressure axial fans.

### BACKGROUND OF THE INVENTION

Carbon emissions being emitted from fossil fuel-burning vehicles are a major problem to be solved by government organizations across the globe. Vehicles including turbofan engines and aircraft contribute to atmospheric levels of carbon dioxide and other greenhouse gases in the atmosphere.

Based on the reports of Intergovernmental Panel on Climate Change (IPCC) 2014 on global emissions in 2010, it states that in the case of jet engines the transportation sector contributes 14% of the total greenhouse gas emissions. It is known (compare J. E. Penner et al.: “Aviation and the Global Atmosphere” IPCC, 1999, Technical Report, Cambridge University Press) that climate-relevant effects of air traffic are due, in particular, to the following three engine emission products: water vapour (1.25 kg), carbon dioxide (3.15 kg), and nitrogen oxides (5-25 g).

Particularly, the aircraft engine emissions tend to have a disproportionate effect on atmospheric carbon and greenhouse gas levels than the emissions of other vehicles because they are released into the upper troposphere and lower stratosphere where they may persist for longer periods of time. Therefore, the aviation industry is estimated to contribute about 2 to 3% of all human-generated emissions and about 12% of the transportation sector's emissions. According to a study from the Air Transport Action Group (ATAG), worldwide flights produces about 770 million tonnes of carbon dioxide in the year 2015 alone, and subsequently this will increase with time due to increase in globalization across the globe.

Generally, the turbofan or a jet engine is a type of a Low Pressure Axial Fan (LPAF), which is widely used in aircraft propulsion. In jet engines there are two major components. The two major components are the turbofan and the Low Pressure (LP) turbine & compressors that are connected. In operation, both the components rotate at the same rate. However, for optimal performance, the turbofan needs to operate at a slower rate, whereas the LP turbine & compressors are required to operate at a higher rate.

In order to reduce aircraft greenhouse gas emissions numerous measures have been taken in recent past. Conventionally, the Geared Turbofan (GTF) technology increases the turbofan ability to draw in air into the turbofan engine, and subsequently thereby reduces the fuel consumption, which leads to higher efficiency and overall engine noise. Therefore, the GTF is essentially an inclusion of a Planetary Reduction Gearbox between the turbofan and LP shaft connecting the LP turbine & compressor. Subsequently, the Geared Turbofan (GTF) technology allows the turbofan component and the LP turbine & compressor component to operate at their respective optimal rates.

However, the Geared Turbofan (GTF) consists of multiple gears as its moving parts. Consequently, the Geared Turbofan (GTF) is susceptible to wear and tear. According to industry reports available in the public domain, it is suggested that the geared turbofan requires longer time duration to cool down than the industry calculated time duration for the whole process to avoid uneven wear and tear when the GTF is restarted. Moreover, providing the longer time duration to cool down the Geared Turbofan (GTF) at a busy airport can delay the takeoff time of the aircraft and can subsequently cost a plane its takeoff slot. Therefore, there remains a need to develop a new system, which can be used in conjunction with Geared Turbofan (GTF) to increase the total efficiency of turbofan engines.

Furthermore, while utilizing computer-cooling fans, there is increase in speed and power consumption. Particularly, the computer cooling fan includes one or more processors, graphics cards, RAM and other components related to computers. However, the amount of heat produced by these components needs to be controlled as it affects normal operation of the turbofan engines. In operation, these components of the computer cooling fan need to be kept within a specified temperature range to prevent overheating, instability, malfunction and damage that generally leads to a shortened life span of the component.

Currently, for cooling one or more components within a computer, they're several types of systems besides the conventional computer-cooling fan, such as the ionic wind and liquid cooling. The ionic wind system consists of two charged metal plates, one positively charged, and the other one is negatively charged. However, over time, the ionic wind system suffers from the disadvantage of losing efficiency as the charged metal plates readily undergo oxidation with the surrounding oxygen.

Moreover, the process of installing liquid cooling into computers is known to incur high cost, and at the same time possesses high installation complexity. Subsequently, the utilization of liquid cooling method suffers from the disadvantage and leaves a larger margin for system failure. With technological advances in the current era where the idea of making devices smaller for certain specifies use such as technological wearables, one can anticipate that the computer cooling fans could be downsized in near future. There remains a need to develop systems, methods and apparatus that would enable movements of large volumes of air for cooling and the same can be used for downsized cooling fans.

Accordingly, there remains a need in the art to develop new method that will be able to increase the efficiency of turbofan engines and subsequently decrease the aviation industry's carbon footprint.

### SUMMARY OF THE INVENTION

In accordance with an embodiment of the present invention, a system for increasing the efficiency of low pressure axial fans, including, a low pressure axial fan including multiple first blades, and, a vortex generator operably coupled to the low pressure axial fan via a shaft. In use, the vortex generator includes multiple second blades. In further use, the low pressure axial fan is configured to operate in an operational mode and the vortex generator is configured to operate in a stationary mode.

The embodiments of the present disclosure have several features, no single one of which is solely responsible for their desirable attributes. Without limiting the scope of the present embodiments as expressed by the claims that follow, their more prominent features will now be discussed briefly. After considering this discussion, and particularly after reading the section entitled “Detailed Description”, one will understand how the features of the present embodiments provide advantages, which include providing systems and methods for increasing the efficiency of low pressure axial fans.

### BRIEF DESCRIPTION OF THE DRAWINGS

FIG. 1A, FIG. 1B and FIG. 1C illustrate 3-D views of a system for increasing the efficiency of low pressure axial fans, according to an embodiment of the invention;

FIG. 2 illustrates a side view of the system for increasing the efficiency of low pressure axial fans, according to an embodiment of the invention;

FIG. 3 illustrates an isometric view of the system for increasing the efficiency of low pressure axial fans, according to an embodiment of the invention;

FIG. 4 illustrates an application of the system for increasing the efficiency of low pressure axial fans, according to an embodiment of the invention; and,

FIG. 5 illustrates a sectional view of the system for increasing the efficiency of low pressure axial fans, according to an embodiment of the invention.

### DETAILED DESCRIPTION OF THE INVENTION

Various embodiments of the present invention are disclosed herein below, which relate to systems and methods for increasing the efficiency of low pressure axial fans.

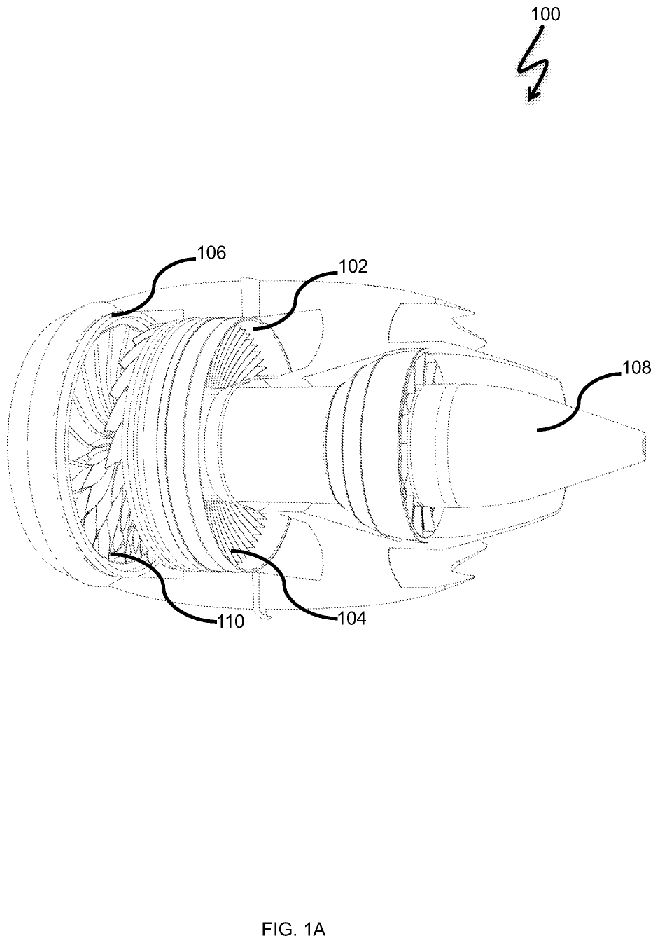

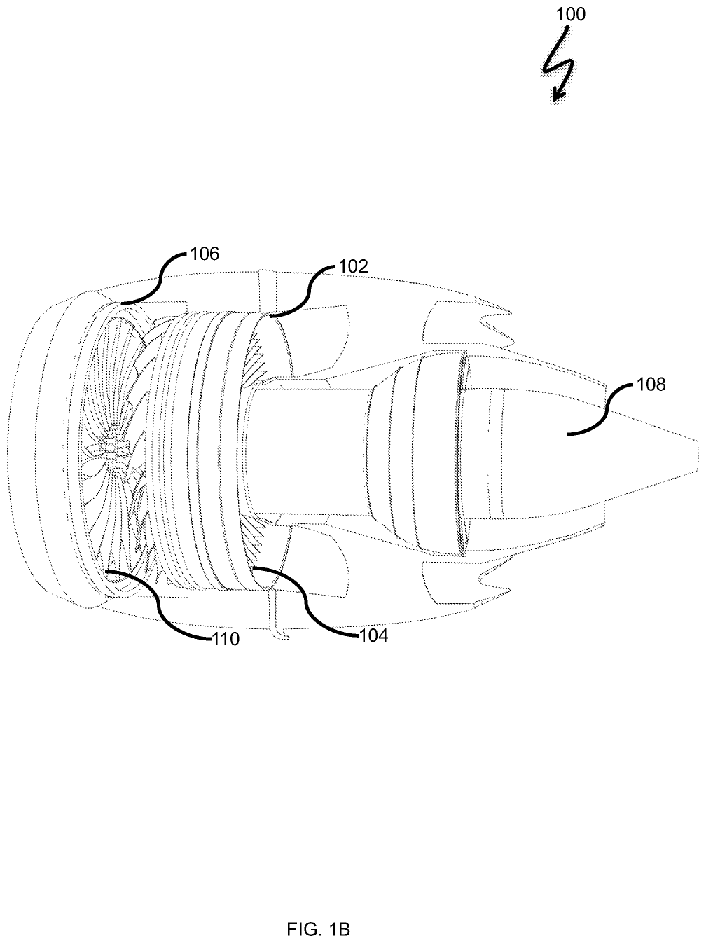

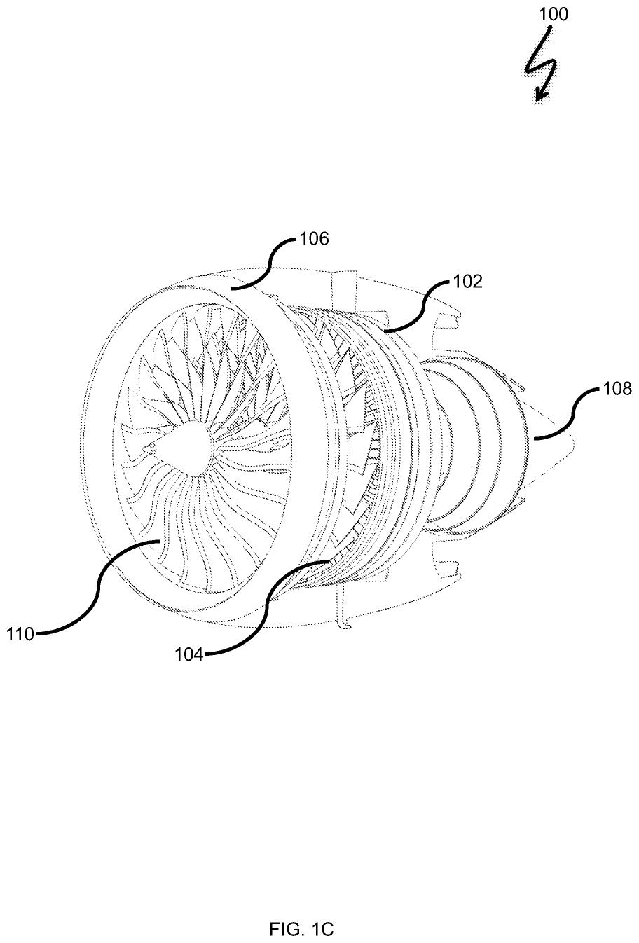

FIG. 1A, FIG. 1B and FIG. 1C illustrate 3-D views of a system 100 for increasing the efficiency of low pressure axial fans, according to an embodiment of the invention. In accordance with an embodiment of the present invention, the system 100 for increasing the efficiency of low pressure axial fans includes, a low pressure axial fan 102 including multiple first blades 104, and, a vortex generator 106 operably coupled to the low pressure axial fan 102 via a shaft 108. In use, the vortex generator 106 includes multiple second blades 110. In further use, the low pressure axial fan 102 is configured to operate in an operational mode and the vortex generator 106 is configured to operate in a stationary mode.

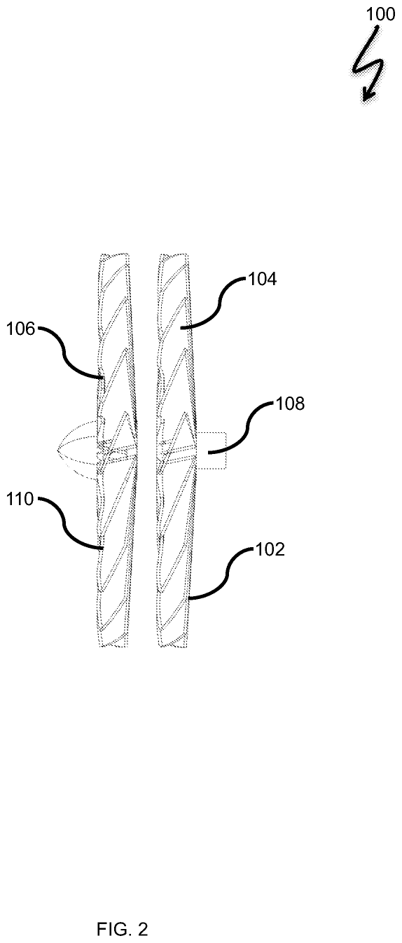

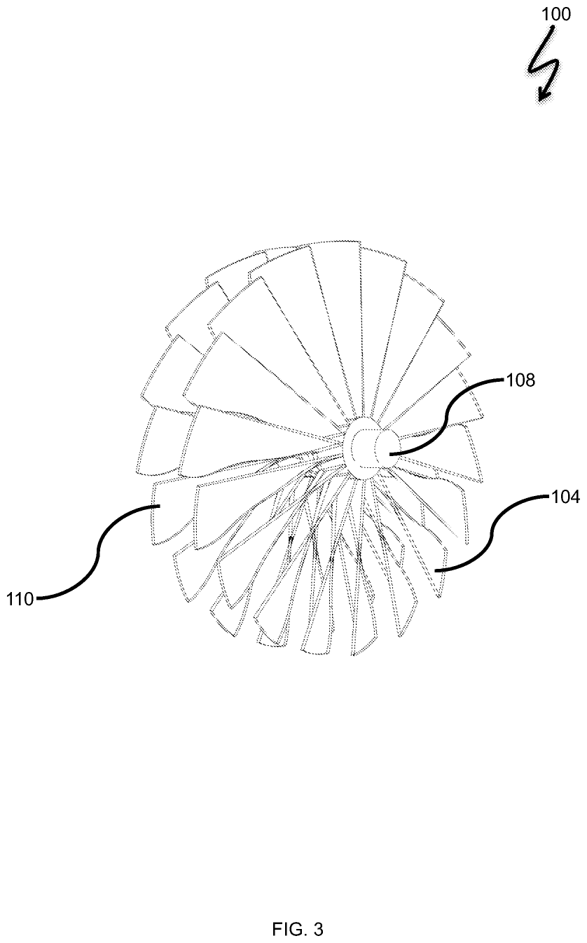

FIG. 2 illustrates a side view of the system for increasing the efficiency of low pressure axial fans, and, FIG. 3 illustrates an isometric view of the system for increasing the efficiency of low pressure axial fans. In accordance with an embodiment of the present invention, the low pressure axial fan 102 and the vortex generator 106 are mounted parallel to each other. In use, the shaft 108 is a rotational shaft.

In accordance with an embodiment of the present invention, the low pressure axial fan 102 and the vortex generator 106 are mounted parallel to each other with a specific distance between them in a manner such that the vortex generator 106 generates a vortex similar to the low pressure axial fan 102, thereby enabling the low pressure axial fan 102 to draw in/expel more air for a same amount of energy supplied.

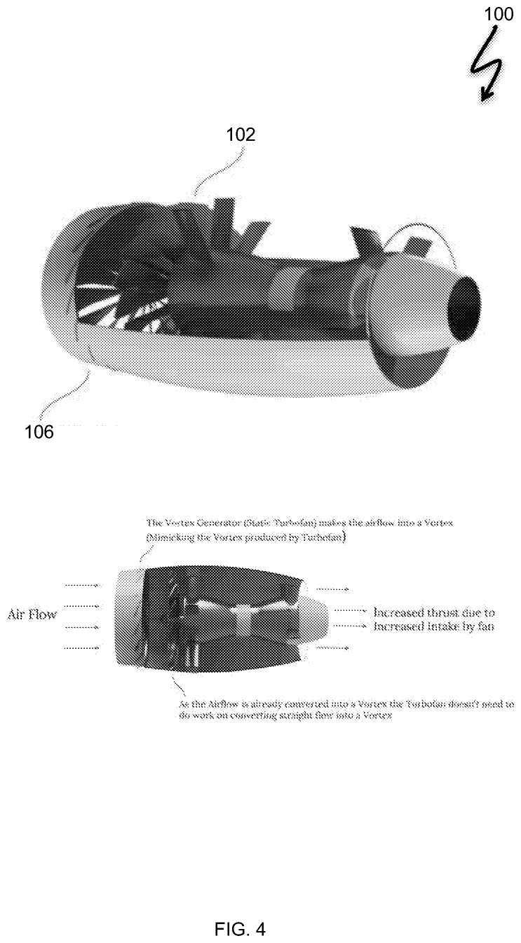

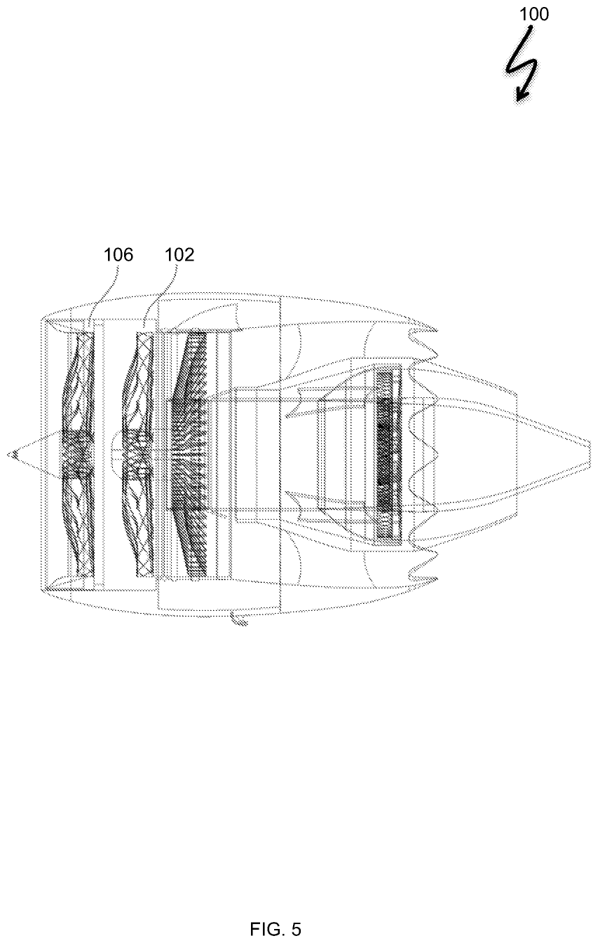

FIG. 4 illustrates an application of the system for increasing the efficiency of low pressure axial fans, and, FIG. 5 illustrates a sectional view of the system for increasing the efficiency of low pressure axial fans. In accordance with an embodiment of the present invention, the low pressure axial fan 102 and the vortex generator 106 are mounted parallel to each other with the specific distance between them for converting ambient air into the output airflow of the system 100.

In accordance with an embodiment of the present invention, the efficiency of the low pressure axial fan 102 increases with a decrease in distance between the low pressure axial fan 102 and the vortex generator 106. Specifically, the low pressure axial fan 102 is most efficient when the low pressure axial fan 102 and the vortex generator 106 are at the least possible distance.

In accordance with an embodiment of the present invention, number of the first blades 104 of the low pressure axial fan 102 is equal to number of the second blades 110 of the vortex generator 106.

In accordance with an embodiment of the present invention, the vortex generator 106 is mounted parallel to the low pressure axial fan 102 on a front side of the low pressure axial fan 102. Specifically, the Vortex Generator 106 is placed parallel to the low pressure axial fan 102 on the side of which air is drawn by the low pressure axial fan 102.

In accordance with an embodiment of the present invention, a method for increasing the efficiency of low pressure axial fans includes the steps of, providing a low pressure axial fan including multiple first blades, providing a vortex generator and operably coupling the vortex generator to the low pressure axial fan via a shaft, and, operating the low pressure axial fan in an operational mode and the vortex generator in a stationary mode.

Therefore, as may be seen, various embodiments of the present invention provide significant advantages over prior art, such as, for example, but not limited to, increasing an engine's efficiency without involving any form of moving parts, reducing wear and tear, low maintenance costs, and the like. In the application areas of computer cooling, the present invention possesses all the simplicity of current conventional computer fans, but with a stronger ventilation ability. Additionally, embodiments of the present invention are less sophisticated and will be much easier to integrate into existing designs of jet engines, computer exhaust fans, and the like.

Moreover, embodiments of the present invention are aimed at drastically reducing Aviation Industry's Carbon Footprint, thereby increasing air travel's accessibility. Furthermore, the present invention will be able to save 30% of fuel consumed by a flight via integrating the Vortex Generating system as discussed herein, which is literally thousands of Gallons for a typical international trip, thereby decreasing air pollution and simultaneously increasing the accessibility of air travel.

Specifically, by using Static (fixed) LPAF as the Vortex Generator, the Thrust Specific fuel consumption of a typical Turbofan Engine is decreased by around 30%, and as the Static LPAF is fixed at the front of the Engine, there's a “barrier” to shield potential humans and/or birds from unintentionally getting sucked into the Engine. Also, the present invention is very simple to integrate into the existing Turbofan Engine models.

While there has been shown and described the preferred embodiment of the instant invention it is to be appreciated that the invention may be embodied otherwise than is herein specifically shown and described and that, within the embodiment, certain changes may be made in the form and arrangement of the parts without departing from the underlying ideas or principles of this invention as set forth in the Claims appended herewith. Therefore, the appended claims are to be construed to cover all equivalents falling within the true scope and spirit of the invention.

I claim:

1. A system for increasing the efficiency of low pressure axial fans, said system comprising:
a low pressure axial fan comprising a plurality of first blades;
a vortex generator operably mounted proximal to said low pressure axial fan, said vortex generator comprising a plurality of second blades; and,
a shaft operably connected to said low pressure axial fan to provide rotational energy from at least one external source of energy,
wherein said low pressure axial fan is configured to operate in an operational mode and said vortex generator is configured to operate in a stationary mode.

2. The system as claimed in claim 1, wherein said low pressure axial fan and said vortex generator are mounted parallel to each other.

3. The system as claimed in claim 1, wherein said shaft is a rotational shaft.

4. The system as claimed in claim 1, wherein said low pressure axial fan and said vortex generator are mounted parallel to each other with a specific distance between them in a manner such that said vortex generator generates a vortex similar to said low pressure axial fan, thereby enabling said low pressure axial fan to draw in/expel more air for a same amount of energy supplied.

5. The system as claimed in claim 1, wherein said low pressure axial fan and said vortex generator are mounted parallel to each other with said specific distance between them for converting ambient air into the output airflow of said system.

6. The system as claimed in claim 1, wherein efficiency of said low pressure axial fan increases with a decrease in distance between said low pressure axial fan and said vortex generator.

7. The system as claimed in claim 1, wherein number of said plurality of first blades of said low pressure axial fan is equal to number of said plurality of second blades of said vortex generator.

8. The system as claimed in claim 1, wherein said vortex generator is mounted parallel to said low pressure axial fan on a front side of said low pressure axial fan.

9. A method for increasing the efficiency of low pressure axial fans, said method comprising the steps of:
providing a low pressure axial fan comprising a plurality of first blades;
providing a vortex generator operably and mounting said vortex generator proximal to said low pressure axial fan, said vortex generator comprising a plurality of second blades;
providing a shaft and operably connecting said shaft to said low pressure axial fan to provide rotational energy from at least one external source of energy; and,
operating said low pressure axial fan in an operational mode and said vortex generator in a stationary mode.
